(19) United States
(12) Patent Application Publication
(10) Pub. No.: US 2016/0300412 A1
(43) Pub. Date: Oct. 13, 2016

(54) COMMUNICATION SYSTEM FOR VEHICLE

(71) Applicant: HON HAI PRECISION INDUSTRY CO., LTD., New Taipei (TW)

(72) Inventor: HUNG-CHANG KO, New Taipei (TW)

(21) Appl. No.: 14/847,808

(22) Filed: Sep. 8, 2015

(30) Foreign Application Priority Data
Apr. 10, 2015 (TW) 104111516

(51) Int. Cl. G07C 9/00

(52) U.S. Cl. CPC G07C 9/00119; G07C 9/00309; G07C 2009/00769

(57) ABSTRACT

A communication system for a vehicle includes a vehicle and a portable communication device. The vehicle includes a low frequency antenna and an ultra high frequency (UHF) antenna. The portable communication device includes a low frequency antenna and a UHF antenna. Signals are transmitted from the vehicle to the portable communication device via the low frequency antenna. Signals are transmitted from the portable communication device to the vehicle via the UHF antenna. Periodic detecting signals, and challenge signals on detection, are broadcast by the vehicle, and received by the low frequency antenna of the portable communication device. Doors of the vehicle are unlocked and the engine of the vehicle may be started when the return signals from the UHF antenna of the portable communication device are authenticated by the vehicle.

### FIELD

The subject matter herein generally relates to communication systems.

### BACKGROUND

Generally, low frequency antenna is utilized in communication between a vehicle and an electronic key, especially in the position detection and the authentication. However, the size and the cost of the low frequency antenna is large.

### BRIEF DESCRIPTION OF THE DRAWINGS

Implementations of the present technology will now be described, by way of example only, with reference to the attached figures.

FIG. 1 illustrates a communication system according to the present embodiment.

FIG. 2 is a signal diagram for communication between the vehicle and the portable communication device in accordance with the communication system of FIG. 1.

FIG. 3 is another signal diagram for communication between the vehicle and the portable communication device in accordance with the communication system of FIG. 1.

FIG. 4 is a block diagram of a vehicle according to the present embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

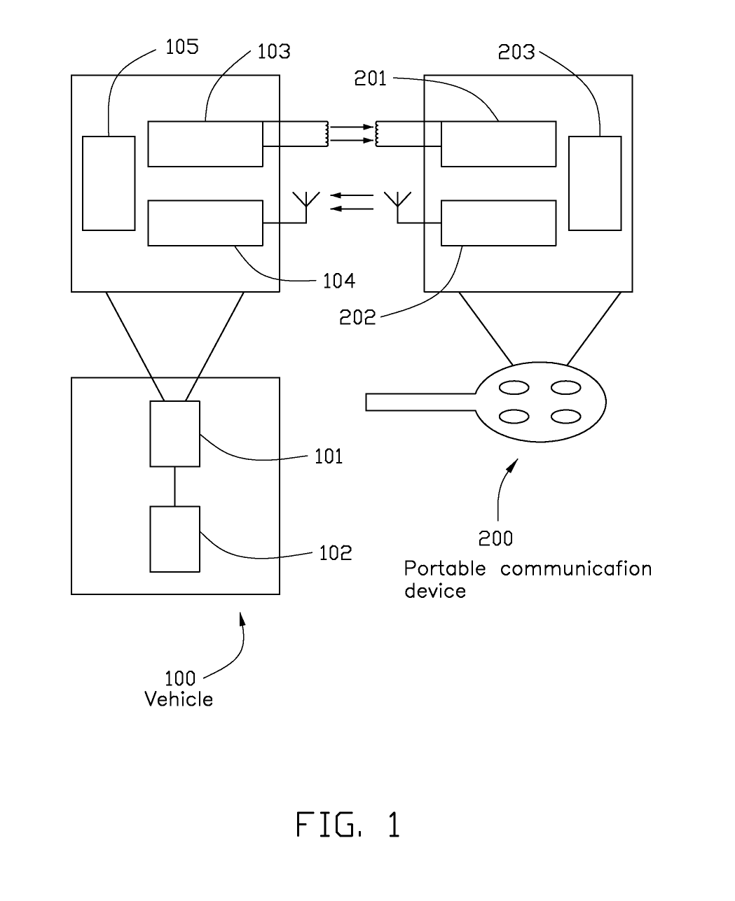

FIG. 1 illustrates an embodiment of a communication system 300 which can include a vehicle 100 and a portable communication device 200. The portable communication device 200 is a key of the vehicle 100. The vehicle 100 includes a base station circuit 101 and a vehicle control unit (VCU) 102. The base station circuit 101 is electrically coupled to the vehicle control unit (VCU) 102. The base station circuit 101 includes a first low frequency antenna 103, a first ultra high frequency antenna 104, and a microcontroller 105. The portable communication device 200 includes a second low frequency antenna 201, a second ultra high frequency antenna 202 and a second microcontroller 203.

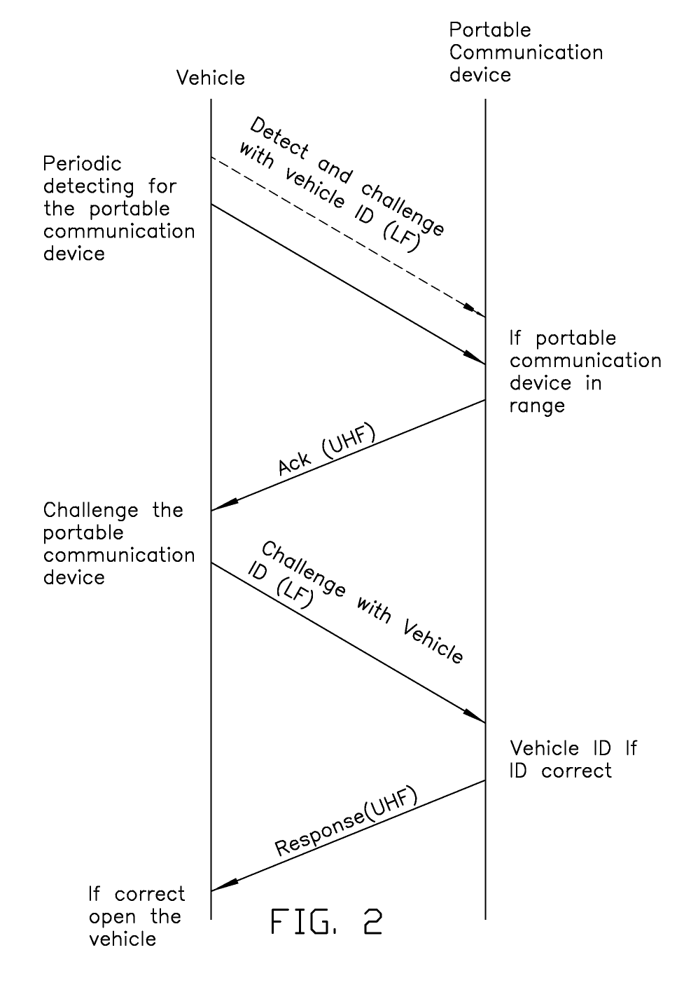

In one embodiment of the present disclosure, as shown in FIG. 2, the base station circuit 101 of the vehicle 100 periodically transmits a periodic detecting signal to detect any portable communication device 200. When the portable communication device 200 is within a certain range around the vehicle 100 and the periodic detecting signal from the base station circuit 101 is received by the portable communication device 200, a signal for authentication is transmitted from the portable communication device 200 to the base station circuit 101 of the vehicle 100 via the ultra high frequency antenna 202 of the portable communication device 200. A challenge signal with vehicle identification number (Vehicle ID) is transmitted from the base station 101 to the portable communication device 200 via the first low frequency antenna 103. The challenge signal with vehicle identification number (Vehicle ID) is received by the portable communication device 200 via the low frequency antenna 201 and the challenge signal with vehicle identification number (Vehicle ID) can be analyzed and authenticated by the second microcontroller 203 of the portable communication device 200.

When the challenge signal with vehicle identification number (Vehicle ID) is authenticated by the second microcontroller 203 of the portable communication device 200, an authentication response signal is transmitted from the portable communication device 200 to the base station circuit 101 of the vehicle 100 via the ultra high frequency antenna 202 of the portable communication device 200. When the authentication response signal is received and authenticated by the first microcontroller 105, a grant access signal is transmitted to the vehicle control unit (VCU) 102. Then, doors of the vehicle 100 are controlled by the vehicle control unit (VCU) 102 to be unlocked and an engine of the vehicle can be allowed to start. If the authentication response signal is not authenticated by the microcontroller 105, a deny access signal is transmitted to the vehicle control unit (VCU) 102. In the case of the deny access signal, the doors of the vehicle 100 remain locked and the engine is not allowed to start.

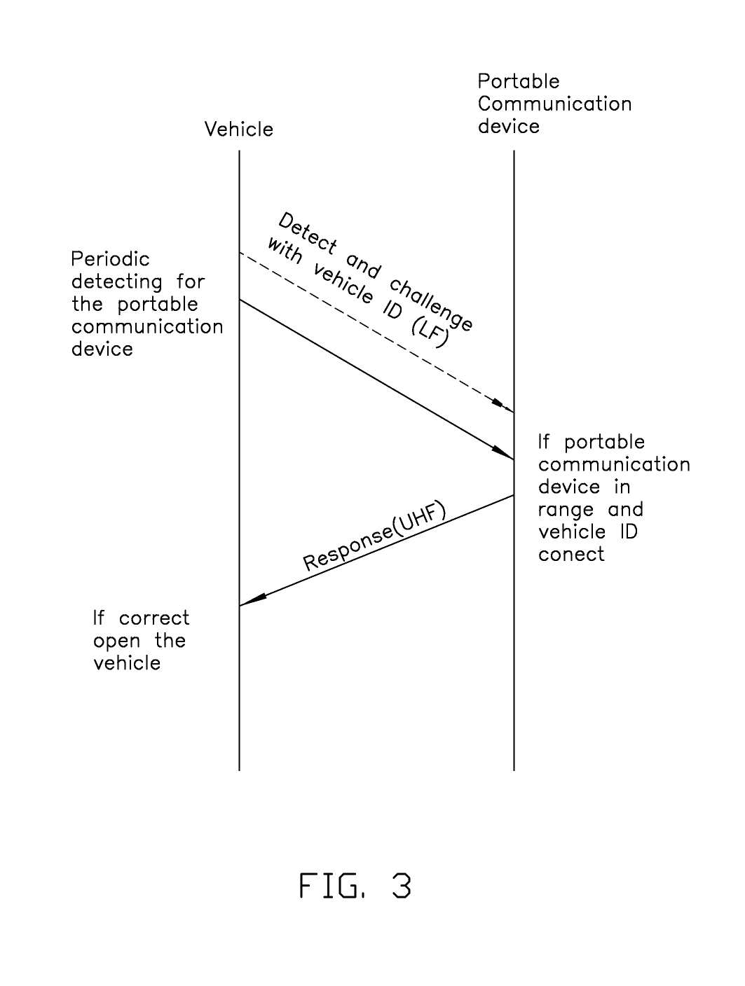

In one embodiment of the present disclosure, as shown in FIG. 3, when the portable communication device 200 is detected within the certain range around the vehicle 100, an asking signal for authentication and the challenge signal with vehicle identification number are combined into one signal and transmitted from the base station circuit 101 of the vehicle 100 to the portable communication device 200, via the first low frequency antenna 103 of the vehicle 100. The asking signal for authentication and the authentication response signal are combined into one signal and transmitted from the portable communication device 200 to the base station circuit 101 of the vehicle 100, via the ultra high frequency antenna 202 of the portable communication device 200. When the signal combining the asking signal for authentication and the authentication response signal is received and authenticated by the microcontroller 105, doors of the vehicle 100 can be unlocked and an engine of the vehicle can be allowed to start. If the authentication response signal is not authenticated by the microcontroller 105, the doors of the vehicle 100 cannot be unlocked and the engine of vehicle will not be allowed to start.

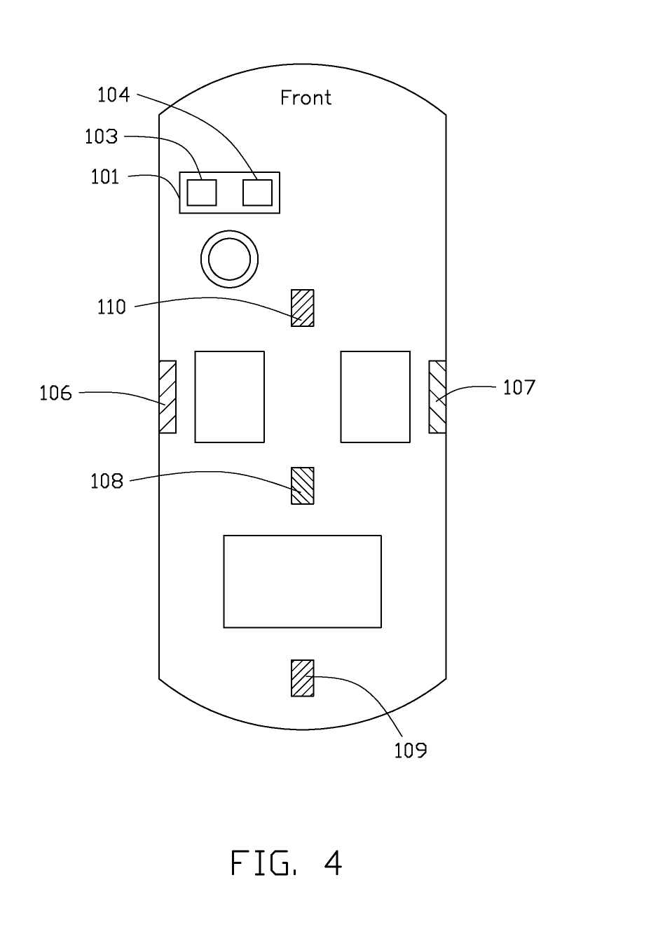

In one embodiment of the present disclosure, as shown in FIG. 4, the vehicle 100 further includes a third low frequency antenna 106, a fourth low frequency antenna 107, a fifth low frequency antenna 108, and a sixth low frequency antenna 109. The third low frequency antenna 106, the fourth low frequency antenna 107, the fifth low frequency antenna 108, and the sixth low frequency antenna 109 are arranged around the vehicle 100.

A position of the portable communication device 200 can be determined by the low frequency antennas 103, 106, 107, 108, and 109, and the first ultra high frequency antenna 104 of the vehicle 100 and by the second low frequency antenna 201 and the second ultra high frequency antenna 202 of the portable communication device 200.

In one embodiment of the present disclosure, the vehicle 100 further includes a third ultra high frequency antenna 110 arranged in the middle of the vehicle. The position detection of the portable communication device 200 can then be determined by the low frequency antennas 103, 106, 107, 108, and 109 and the ultra high frequency antennas 104 and 202 of the vehicle 100 and the second low frequency antenna 201 and the second ultra high frequency antenna 202 of the portable communication device 200.

The embodiments shown and described above are only examples. Many details are often found in the art such as the other features of a vehicle communication system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A communication system comprising:
a vehicle comprising a first low frequency antenna, a first ultra high frequency antenna and a microcontroller; and
a portable communication device comprising a second low frequency antenna and a second ultra high frequency antenna;
wherein, a periodic detecting signal and a challenge signal are transmitted from the vehicle to the portable communication device via the first low frequency antenna;
wherein, signals are transmitted from the portable communication device to the vehicle via the second ultra high frequency antenna when the periodic detecting signal and the challenge signal are received by the second low frequency antenna of the portable communication device; and
wherein, at least one lock of the vehicle is unlockable when the signals are analyzed and authenticated by the microcontroller of the vehicle and the lock of the vehicle are not unlockable when the signals are not authenticated by the vehicle.

2. The communication system of claim 1, wherein the signals transmitted from the portable communication device to the vehicle via the second ultra high frequency antenna are a signal for authentication and challenge response signal.

3. The communication system of claim 2, wherein the periodically detecting signal and the challenge signal are combined into one signal and transmitted from the vehicle to the portable communication device, and the signal for authentication and challenge response signal are combined into one signal and transmitted from the portable communication device to the vehicle.

4. The communication system of claim 2, wherein the signal for authentication is transmitted from the portable communication device to the vehicle when the periodic detecting signal of the vehicle is received by the portable communication device, the challenge signal is transmitted from the vehicle to the portable communication device when the signal for authentication is received by the vehicle, and the challenge response signal is transmitted from the portable communication device to the vehicle when the challenge signal is received by the portable communication device.

5. The communication system of claim 2, the vehicle further comprising at least one second low frequency antenna and at least one second ultra high frequency antenna, the position of the portable communication device is determined by the first low frequency antenna, the second the least one second low frequency antenna and the first ultra high frequency antenna of the vehicle.

6. The communication system of claim 2, the vehicle further comprising at least one second low frequency antenna and at least one second ultra high frequency antenna, the position of the portable communication device is determined by the first low frequency antenna, the second the least one second low frequency antenna, the first ultra high frequency antenna and at least one second ultra high frequency antenna of the vehicle.

7. A communication system, comprising:
a vehicle, comprising a first low frequency antenna and a first ultra high frequency antenna; and
a portable communication device, comprising a first second low frequency antenna and a second Ultra high frequency antenna;
wherein, a periodic detecting signal and a challenge signal are transmitted from the vehicle to the portable communication device via the first low frequency antenna;
wherein, a signal for authentication and challenge response signal are transmitted from the portable communication device to the vehicle via the second ultra high frequency antenna when the periodic detecting signal and the challenge signal are received by the second low frequency antenna of the portable communication device; and
wherein, the doors of the vehicle can be unlocked when the authentication response signal is analyzed and authenticated by the vehicle and the doors of the vehicle remain locked when the authentication response signal is not authenticated by the vehicle.

8. The communication system of claim 7, wherein the periodic detecting signal and the challenge signal are combined into one signal and transmitted from the vehicle to the portable communication device, and the signal for authentication and challenge response signal are combined into one signal and transmitted from the portable communication device to the vehicle.

9. The communication system of claim 7, wherein the signal for authentication is transmitted from the portable communication device to the vehicle when the periodically detecting signal of the vehicle is received by the portable communication device, the challenge signal is transmitted from the vehicle to the portable communication device when the asking signal for authentication is received by the vehicle, and the challenge response signal is transmitted from the portable communication device to the vehicle when the challenge signal is received by the portable communication device.

10. The communication system of claim 7, the vehicle further comprising at least one second low frequency antenna and at least one second ultra high frequency antenna, the position of the portable communication device is determined by the first low frequency antenna, the second the least one second low frequency antenna and the first ultra high frequency antenna of the vehicle.

11. The communication system of claim 7, the vehicle further comprising at least one second low frequency antenna and at least one second ultra high frequency antenna, the position of the portable communication device is determined by the first low frequency antenna, the second the least one second low frequency antenna, the first ultra high frequency antenna and at least one second ultra high frequency antenna of the vehicle.
